(19) United States
(12) Patent Application Publication
(10) Pub. No.: US 2016/0165431 A1
(43) Pub. Date: Jun. 9, 2016

(54) MME SELECTION UPON INTER-RAT MOBILITY FROM GERAN/UTRAN TO E-UTRAN

(71) Applicant: NOKIA SOLUTIONS AND NETWORKS OY, Espoo, OT (FI)

(72) Inventors: Devaki Chandramouli, Plano, TX (US); Joanna Pauliina Jokinen, Espoo (FJ); Pekka Tapio Jaske, Sammamish, WA (US); Paula Hannele Siren, Vantaa (FI)

(21) Appl. No.: 14/903,430

(22) PCT Filed: Jul. 2, 2014
(86) PCT No.: PCT/EP2014/064082

§ 371 Date: Jan. 7, 2016

Related U.S. Application Data
(60) Provisional application No. 61/843,573, filed on Jul. 8, 2013.

(51) Int. Cl. H04W 8/10; H04W 36/14; H04W 36/00

(52) U.S. Cl. CPC H04W 8/10; H04W 36/0022; H04W 36/14; H04W 88/10

(57) ABSTRACT

It is provided a method, comprising monitoring whether an apparatus will perform a first mobility procedure from a first network of a first radio access technology to a first other network of a second radio access technology; storing an old identifier, wherein the old identifier identifies a first network element of the first network to which the apparatus is registered before the first mobility procedure starts; monitoring whether the apparatus performs a second mobility procedure from a second other network of a third radio access technology to a second network of the first technology; retrieving the stored old identifier; providing a mapped identifier and the retrieved old identifier to a base station of the second network when the apparatus performs the second mobility procedure, wherein the mapped identifier is based on an identification of a part of the second other network to which the apparatus is registered.

### FIELD OF THE INVENTION

The present invention relates to an apparatus, a method, a system, and a computer program product related to mobile communication networks. More particularly, the present invention relates to an apparatus, a method, a system, and a computer program product embodying a concept of Network element selection upon inter-RAT mobility.

### BACKGROUND OF THE INVENTION

### Abbreviations

2G 2^{nd} generation
3G 3^{rd} generation
3GPP 3^{rd} Generation Partnership Project
AKA Authentication and Key Agreement
AS Access stratum
BSC Base Station Controller
CDMA Code Division Multiple Access
EDGE Enhanced Data rates for Global Evolution
eNB evolved NodeB
EPS Evolved Packet System
E-UTRAN evolved UTRAN
GERAN GSM Edge RAN
GPRS General Packet Radio Service
GUMMEI Globally Unique MME Identifier
GUTI Globally Unique Temporary Identifier
HLR Home Location Register
HO Handover
HPLMN Home PLMN
HSS Home Subscriber Server
IE Information Element
IP Internet Protocol
ISR Idle mode signalling reduction
LTE™ Long Term Evolution
LTE-A™ Long Term Evolution-Advanced
MCC Mobile Country Code
MME Mobility management entity
MNC Mobile Network Code
NAS Non access stratum
PDN-GW Packet Data Network Gateway
PDP Packet Data Protocol
PGW Packet Gateway
PLMN Public Land Mobile Network
P-TMSI P-Temporary Mobile Subscriber Identity
RAI Routing Area Identity
RAN Radio Access Network
RAT Radio access technology
RNC Radio Network Controller
RRC Radio Resource Control
SGSN Serving GPRS Support Node
SGW Serving Gateway
TAU Tracking Area Update
TIN Temporary Identity used in Next update
TS Technical Specification
UE User Equipment
UMTS Universal Mobile Telecommunication System
UTRAN UMTS RAN
WCDMA Wideband Code Division Multiplex Access
WiFi™ Wireless Fidelity

EPS is the Evolved Packet System, the successor of GPRS (General Packet Radio System). It provides new radio interface and new packet core network functions for broadband wireless data access. Such EPS core network functions are the Mobility Management Entity (MME), Packet Data Network Gateway (PDN-GW) and Serving Gateway (S-GW).

FIG. 1 shows the EPS architecture, based on 3GPP TS 23.401. Thin lines represent control plane interfaces, whereas thick lines represent user plane interfaces.

On the left side, different radio access networks (GERAN (2G), UTRAN (3G), and E-UTRAN) are shown. A common packet domain Core Network is used for both Radio Access Networks (RAN) the GERAN and the UTRAN. This common Core Network provides GPRS services. It is represented by SGSN.

On the other hand, corresponding to SGSN for GERAN and UTRAN, E-UTRAN is connected to MME. MME and SGSN may be combined in a single platform named combo MME/SGSN, marked by a dotted box in FIG. 1.

The MME, for example, is used as a control node for processing the signaling between the UE (via E-UTRAN) and the core network. It may have functions related to bearer management (establishment, maintenance and release of bearers), connection management and inter-working with other networks. Furthermore, functions related to localizing and management of UEs being in an idle mode may be done by the MME. For this purpose, an MME manages all UEs being located in a so called tracking area, wherein each tracking area may consist of one or more cells controlled by a corresponding communication network control element (e.g. an eNB). It is to be noted that a cell may belong to one or more tracking areas. Generally, when a UE enters or changes a tracking area, it conducts a TAU procedure so that the MME is aware of the tracking area where the UE is reachable. If plural MMEs are available for a cell, these MMEs form a MME pool.

eNB uses the GUMMEI for MME selection. The GUMMEI comprises MCC, MNC, ME group ID, and MME code, thus unambiguously defining the MME.

ISR allows a UE to remain simultaneously registered in an UTRAN/GERAN routing area and an E-UTRAN tracking area list. When ISR is not activated, upon inter-RAT mobility (e.g. to E-UTRAN), UE provides a mapped GUMMEI in the RRC message. The mapped GUMMEI is generated based on the UTRAN/GERAN routing area (its RAI) to which the UE belongs before inter-RAT HO starts.

Since the GUMMEI is mapped, it is mapped by the eNB to a pool of MMEs eNB which typically comprises more than one MME. That is, eNB is unable to select a proper standalone MME based on the mapped GUMMEI. Rather, the probability for selecting the correct MME may be low: e.g. in case 3 MMEs form a pool, eNB selects the correct MME only in 33.33% of the cases. Here, a correct MME is the one connected to the eNB performing the selection and the MME having the relevant information of the subscriber such as subscription profile, UE context, a temporary identifier and/or of the session such as a PDP context. E.g. a combo MME/SGSN may have such information if the UE is registered with the SGSN. Thus, typically, selecting a new MME results in subscription query with the HSS, context transfer procedure etc. This results in additional signalling towards the HSS and may require additional capacity in the HSS.

Upon inter RAT mobility from 2G/3G to LTE and if ISR is not activated, UE creates a mapped GUTI (mapped from P-TMSI/RAI). A mapped GUTI comprises the mapped GUMMEI and P-TMSI, which is a temporary identifier of the UE in the 2G/3G network. UE determines the registered MME from the mapped GUTI. UE NAS layer provides the registered MME to the UE AS layer UE AS layer includes this in the RRC message sent to the eNB and eNB uses it for MME selection.

Ericsson (ftp://3gpp.org/tsg_sa/WG2_Arch/TSGS2_81_Prague/Docs/S2-10453.zip) proposed that UE sends the native GUMMEI to the eNB. A native GUMMEI is assigned by the EPC to the UE. However the drawback identified for this approach is that the eNB may not be able to select a combo MME/SGSN node based on the native GUTI including the native GUMMEI.

### SUMMARY OF THE INVENTION

It is an object of the present invention to improve the prior art. In detail, it is an object to improve MME selection at inter-RAT mobility.

According to a first aspect of the invention, there is provided an apparatus, comprising first mobility monitoring processor configured to monitor whether the apparatus is to perform a first mobility procedure from a first network of a first radio access technology to a first other network of a second radio access technology different from the first radio access technology; storing processor configured to store, in a memory, an old identifier when the apparatus is to perform the first mobility procedure, wherein the old identifier identifies a first network element of the first network to which the apparatus is registered before the first mobility procedure starts; second mobility monitoring processor configured to monitor whether the apparatus performs a second mobility procedure from a second other network of a third radio access technology different from the first radio access technology to a second network of the first technology; retrieving processor configured to retrieve the stored old identifier from the memory; providing processor configured to provide a mapped identifier and the retrieved old identifier to a base station of the second network when the apparatus performs the second mobility procedure, wherein the mapped identifier is mapped based on an identification of a part of the second other network to which the apparatus is registered before the second mobility procedure starts.

In the apparatus, at least one of
the first radio access technology may be a long term evolution technology;
the first other network may be one of a global system for mobile communication edge radio access network and a universal mobile telecommunication radio access network; and
the second other network may be one of a global system for mobile communication edge radio access network and a universal mobile telecommunication radio access network.

In the apparatus, at least one of
the first network element may comprise a mobility management entity; and
the part of the second network element may be a routing area.

In the apparatus, the mapped identifier may identify a pool of at least one network element of a kind of the first network element.

In the apparatus, the providing processor may be adapted to provide at least one of a mapped indication indicating that the mapped identifier is mapped and a native indication indicating that the old identifier is native.

According to a second aspect of the invention, there is provided an apparatus, comprising first mobility monitoring means configured to monitor whether the apparatus is to perform a first mobility procedure from a first network of a first radio access technology to a first other network of a second radio access technology different from the first radio access technology; storing means configured to store, in a memory, an old identifier when the apparatus is to perform the first mobility procedure, wherein the old identifier identifies a first network element of the first network to which the apparatus is registered before the first mobility procedure starts; second mobility monitoring means configured to monitor whether the apparatus performs a second mobility procedure from a second other network of a third radio access technology different from the first radio access technology to a second network of the first technology; retrieving means configured to retrieve the stored old identifier from the memory; providing means configured to provide a mapped identifier and the retrieved old identifier to a base station of the second network when the apparatus performs the second mobility procedure, wherein the mapped identifier is mapped based on an identification of a part of the second other network to which the apparatus is registered before the second mobility procedure starts.

In the apparatus, at least one of
the first radio access technology may be a long term evolution technology;
the first other network may be one of a global system for mobile communication edge radio access network and a universal mobile telecommunication radio access network; and
the second other network may be one of a global system for mobile communication edge radio access network and a universal mobile telecommunication radio access network.

In the apparatus, at least one of
the first network element may comprise a mobility management entity; and
the part of the second network element may be a routing area.

In the apparatus, the mapped identifier may identify a pool of at least one network element of a kind of the first network element.

In the apparatus, the providing means may be adapted to provide at least one of a mapped indication indicating that the mapped identifier is mapped and a native indication indicating that the old identifier is native.

According to a third aspect of the invention, there is provided a user equipment, comprising an apparatus according to any of the first and second aspects.

According to a fourth aspect of the invention, there is provided an apparatus, comprising retrieving processor configured to retrieve a mapped identifier and a native identifier out of a message received from a terminal device during a mobility procedure to the apparatus; selecting processor configured to select a selected network element to which the terminal device is to be registered based on at least one of the mapped identifier and the native identifier.

The apparatus may further comprise failure detecting processor configured to detect if the selected network element is not connected to the apparatus; wherein the selecting processor may be configured to select the selected network element based on the native identifier first; and, if the failure detecting processor detects that the selected network element which is selected based on the native identifier is not connected to the apparatus, the selecting processor may be configured to select the selected network element based on the mapped identifier.

In the apparatus, at least one of
the native identifier may identify unambiguously a network element of a kind of the selected network element, and
the mapped identifier may identify a pool of at least one network element of the kind of the selected network element.

The apparatus may belong to a long term evolution radio access technology.

In the apparatus, the selected network element may comprise a mobility management entity.

In the apparatus, the mapped identifier may be based on a routing area of one of a global system for mobile communication edge radio access network and a universal mobile telecommunication radio access network.

According to a fifth aspect of the invention, there is provided an apparatus, comprising retrieving means configured to retrieve a mapped identifier and a native identifier out of a message received from a terminal device during a mobility procedure to the apparatus; selecting means configured to select a selected network element to which the terminal device is to be registered based on at least one of the mapped identifier and the native identifier.

The apparatus may further comprise failure detecting means configured to detect if the selected network element is not connected to the apparatus; wherein the selecting means may be configured to select the selected network element based on the native identifier first; and, if the failure detecting means detects that the selected network element which is selected based on the native identifier is not connected to the apparatus, the selecting means may be configured to select the selected network element based on the mapped identifier.

In the apparatus, at least one of
the native identifier may identify unambiguously a network element of a kind of the selected network element, and
the mapped identifier may identify a pool of at least one network element of the kind of the selected network element.

The apparatus may belong to a long term evolution radio access technology.

In the apparatus, the selected network element may comprise a mobility management entity.

In the apparatus, the mapped identifier may be based on a routing area of one of a global system for mobile communication edge radio access network and a universal mobile telecommunication radio access network.

According to a sixth aspect of the invention, there is provided a base station, comprising an apparatus according to any of the fourth and fifth aspects.

According to a seventh aspect of the invention, there is provided a method, comprising monitoring whether an apparatus performing the method is to perform a first mobility procedure from a first network of a first radio access technology to a first other network of a second radio access technology different from the first radio access technology; storing, in a memory, an old identifier when the apparatus is to perform the first mobility procedure, wherein the old identifier identifies a first network element of the first network to which the apparatus is registered before the first mobility procedure starts; monitoring whether the apparatus performs a second mobility procedure from a second other network of a third radio access technology different from the first radio access technology to a second network of the first technology; retrieving the stored old identifier from the memory; providing a mapped identifier and the retrieved old identifier to a base station of the second network when the apparatus performs the second mobility procedure, wherein the mapped identifier is mapped based on an identification of a part of the second other network to which the apparatus is registered before the second mobility procedure starts.

In the method, at least one of
the first radio access technology may be a long term evolution technology;
the first other network may be one of a global system for mobile communication edge radio access network and a universal mobile telecommunication radio access network; and
the second other network may be one of a global system for mobile communication edge radio access network and a universal mobile telecommunication radio access network.

In the method, at least one of
the first network element may comprise a mobility management entity; and
the part of the second network element may be a routing area.

In the method, the mapped identifier may identify a pool of at least one network element of a kind of the first network element.

The method may further comprise providing at least one of a mapped indication indicating that the mapped identifier is mapped and a native indication indicating that the old identifier is native.

According to an eighth aspect of the invention, there is provided a method, comprising retrieving a mapped identifier and a native identifier out of a message received from a terminal device during a mobility procedure to an apparatus performing the method; selecting a selected network element to which the terminal device is to be registered based on at least one of the mapped identifier and the native identifier.

The method may further comprise detecting if the selected network element is not connected to the apparatus; wherein the selecting is configured to select the selected network element based on the native identifier first; and, if it is detected that the selected network element which is selected based on the native identifier is not connected to the apparatus, the selecting is configured to select the selected network element based on the mapped identifier.

In the method, at least one of
the native identifier may identify unambiguously a network element of a kind of the selected network element, and
the mapped identifier may identify a pool of at least one network element of the kind of the selected network element.

In the method, the apparatus may belong to a long term evolution radio access technology.

In the method, the selected network element may comprise a mobility management entity.

In the method, the mapped identifier may be based on a routing area of one of a global system for mobile communication edge radio access network and a universal mobile telecommunication radio access network.

Each of the methods of the seventh and eighth aspects may be a method of network selection.

According to a ninth aspect of the invention, there is provided a computer program product comprising a set of instructions which, when executed on an apparatus, is configured to cause the apparatus to carry out the method according to any of the seventh and eighth aspects. The computer program product may be embodied as a computer-readable medium.

According to some embodiments of the invention, at least one of the following advantages may be achieved:
signaling effort is reduced;
seamless user experience is improved;
inter-RAT mobility times are shortened.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows an EPC architecture according to 3GPP TS 23.401;

FIG. 2 shows an apparatus according to an embodiment of the invention;

FIG. 3 shows a method according to an embodiment of the invention;

FIG. 4 shows an apparatus according to an embodiment of the invention; and

FIG. 5 shows a method according to an embodiment of the invention.

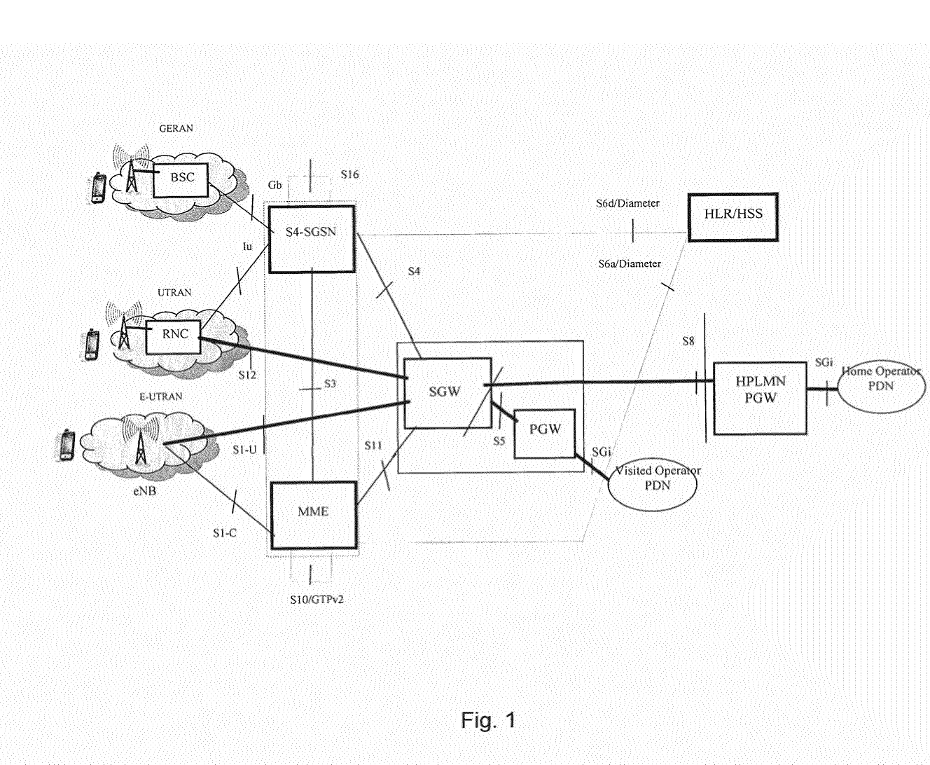

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

Embodiments of the invention are in particular applicable if ISR is not activated.

According to some embodiments of the invention, UE stores a valid (old) GUTI comprising an (old) GUMMEI of a MME to which it is registered when camping in an E-UTRAN network before it performs inter-RAT mobility procedure e.g. to a GERAN or UTRAN network. A valid GUTI comprises the GUMMEI uniquely identifying the MME and M-TMSI, which is a temporary identifier of the UE in the E-UTRAN. UE provides the old GUMMEI and a mapped GUMMEI to eNB for MME selection.

In detail, if the TIN indicates “P-TMSI” and the UE holds a valid GUTI, the UE NAS shall provide the lower layers with the MME identifier part of the mapped GUTI with an indication that the identifier is “mapped”. Additionally, it also includes the native GUTI with an indication that the identifier is a native GUMMEI. The native GUTI corresponds to the stored old GUTI.

An inter-RAT mobility procedure according to some embodiments of the invention comprises the following steps:
Upon inter RAT mobility procedure (e.g. HO in case of connected mode), when TIN indicates “P-TMSI” and the UE holds a valid (old) GUTI, UE NAS provides MME part of the mapped GUTI and old GUTI (=registeredMME) to the UE AS.
UE NAS indicates that this is a mapped GUMMEI and native GUMMEI, respectively, to the UE AS layer. I.e., the old GUMMEI is “labeled” as a native GUMMEI.
UE AS (RRC layer) includes both the mapped GUMMEI and the native GUMMEI (the registered MME) with a respective indicator “mapped” and “native” in the RRC Connection setup complete message sent towards the eNB.
Based e.g. on operator policy, eNB may use either of the 2 GUMMEI(s) to perform MME selection.
In some embodiments, eNB may use both parameters for MME selection. E.g., eNB performs MME selection based on the native GUMMEI (old GUMMEI) first. If this fails (i.e. registeredMME is not connected to the eNB), eNB selects an MME based on mapped GUMMEI.
If these selection procedures result in a failure (i.e. unable to determine an MME connected to the eNB), then the eNB can select a new MME based on e.g. a load balancing algorithm.

In some embodiments, UE NAS layer includes mapped GUTI (mapped from P-TMSI/RAI) in the NAS message that is sent towards the MME. Thus, MME is aware of the temporary identifier of the UE in the 2G/3G RAN.

In addition, in some embodiments, the old GUTI is provided in the NAS message, e.g. as Additional GUTI IE. If the old GUTI is provided, too, MME can retrieve contexts stored within itself with the old GUTI (which was previously a native GUTI). Usually contexts are stored longer in the MME, i.e. even after the UE hands over from the MME. For details, see 3GPP TS 23.401: In the EMM-DEREGISTERED state, some UE context can still be stored in the UE and MME, e.g. to avoid running an AKA procedure during every Attach procedure. Thus, MME may retrieve e.g. security related contexts (i.e. EPS security contexts are not the same as 2G/3G security contexts stored in SGSN).

Since the UE rarely moves across MME (or SGSN) pool boundaries when the device is turned on and it is in network coverage area, MME selection based on old GUTI will yield close to perfect results (i.e. perhaps something like ˜99.5%), which is much better than MME selection based on mapped GUMMEI. Only when there is mobility towards an MME that is not in the MME pool area, the MME selection based on old GUTI will not work. This happens less than e.g. ˜0.5% of the time. Since the mapped GUMMEI will also be included, probability of correct MME selection will be close to e.g. 99.99%.

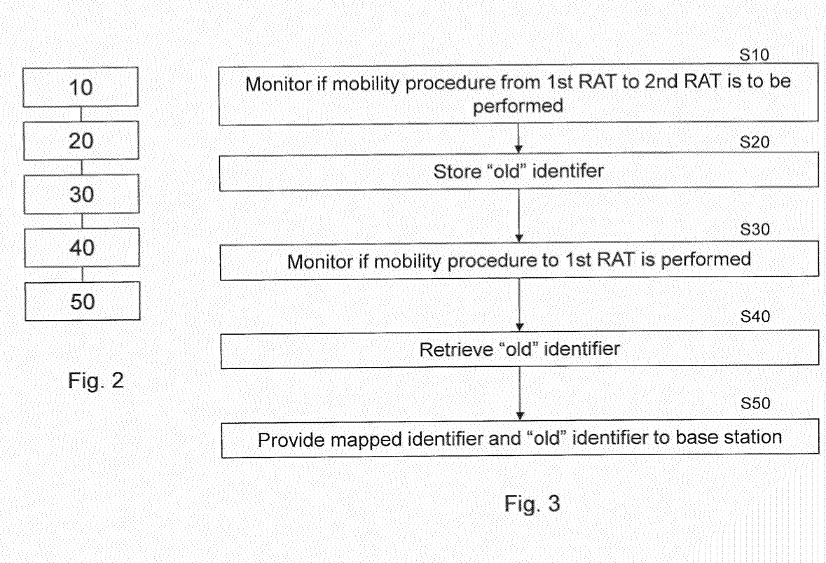

FIG. 2 shows an apparatus according to an embodiment of the invention. The apparatus may be a terminal device such as a UE, or an element thereof. FIG. 3 shows a method according to an embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises first mobility monitoring processor 10, storing processor 20, second mobility monitoring processor 30, retrieving processor 40, and providing processor 50.

The first mobility monitoring processor 10 monitors whether the apparatus is to perform a first mobility procedure from a first network of a first radio access technology (such as E-UTRAN) to a first other network of a second radio access technology (such as GERAN or UTRAN) different from the first radio access technology (S10).

The storing processor 20 stores, in a memory, an old identifier when the apparatus is to perform the first mobility procedure (S20). The old identifier identifies a first network element (such as a MME) of the first network to which the apparatus is registered before the first mobility procedure starts. The old identifier may be a GUMMEI or a GUTI.

The second mobility monitoring processor 30 monitors whether the apparatus performs a second mobility procedure from a second other network of a third radio access technology (such as GERAN or UTRAN) different from the first radio access technology to a second network of the first technology (such as E-UTRAN) (S30). The first other network may be the same as or different from the second other network. The second network may be the same as or different from the first network.

The retrieving processor 40 retrieves the stored old identifier from the memory (S40). E.g., it may retrieve the stored old identifier when the second mobility procedure is performed. However, in some embodiments, the old identifier may be retrieved before the second mobility procedure is performed (i.e., the sequence of S30 and S40 may be interchanged).

The providing processor 50 provides a mapped identifier and the retrieved old identifier to a base station (such as an eNB) of the second network when the apparatus performs the second mobility procedure (S50). The mapped identifier is mapped based on an identification of a part of the second other network (such as a routing area) to which the apparatus is registered before the second mobility procedure starts. The mapped identifier may be a mapped GUMMEI or mapped GUTI.

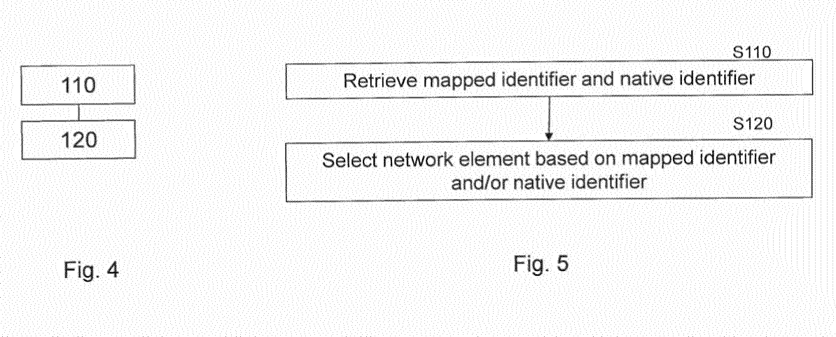

FIG. 4 shows an apparatus according to an embodiment of the invention. The apparatus may be a base station such as an eNB, or an element thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises retrieving processor 110, selecting processor 120.

During a mobility procedure to the apparatus (e.g. in a RRC connection setup complete message), the retrieving processor 110 retrieves a mapped identifier and a native identifier out of a message received from a terminal device such as a UE (S110). Each of the mapped identifier and the native identifier may comprise a GUMMEI or a GUTI. The native identifier may unambiguously define a network element (in particular: a core network element such as a MME) of the network to which the apparatus is connected.

The selecting processor 120 selects a selected network element (e.g. a MME) to which the terminal device is to be registered based on at least one of the mapped identifier and the native identifier (S120). It may use one or both of the identifiers.

Then, an informing processor may inform the terminal device on the selected network element.

In some embodiments, the UE stores the old GUTI of the MME to which it is registered immediately before an inter-RAT mobility procedure away from E-UTRAN takes place. In some embodiments, UE checks if some condition is fulfilled and stores the old GUTI only if the condition is fulfilled. Such conditions may be e.g. a sufficient quality of the session (e.g. in terms of QoS), or a minimum duration of the registration to the particular MME. If the “actual” old GUTI is not stored, a previously stored old GUTI may be kept.

Embodiments of the invention may be employed in an LTE network and a corresponding terminal device (UE). They may be employed also in other networks with corresponding functions like CDMA, EDGE, UMTS, LTE-A, WiFi networks, etc. A terminal (device) or a user equipment may be a mobile phone, a smart phone, a PDA, a laptop or any other terminal which may be attached to the respective network.

The indications that a GUTI/GUMMEI is mapped or native may be explicit or implicit. E.g., each GUTI/GUMMEI may have an IE which indicates whether it is mapped or native. Alternatively, e.g. if plural GUTI/GUMMEI are provided, the sequence may be determined based on the first identifier e.g. if the first identifier is mapped GUMMEI, the second identifier is native GUMMEI or vice versa, the sequence may be fixed, e.g. first mapped IE, then native IE, or vice versa.

The provided/received information may comprise one or more pieces of information related to different meanings. One information may be transmitted in one or plural messages.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a call session control function, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. Apparatus, comprising
first mobility monitoring processor configured to monitor whether the apparatus is to perform a first mobility procedure from a first network of a first radio access technology to a first other network of a second radio access technology different from the first radio access technology;
storing processor configured to store, in a memory, an old identifier when the apparatus is to perform the first mobility procedure, wherein the old identifier identifies a first network element of the first network to which the apparatus is registered before the first mobility procedure starts;
second mobility monitoring processor configured to monitor whether the apparatus performs a second mobility procedure from a second other network of a third radio access technology different from the first radio access technology to a second network of the first technology;
retrieving processor configured to retrieve the stored old identifier from the memory;
providing processor configured to provide a mapped identifier and the retrieved old identifier to a base station of the second network when the apparatus performs the second mobility procedure, wherein the mapped identifier is mapped based on an identification of a part of the second other network to which the apparatus is registered before the second mobility procedure starts.

2. The apparatus according to claim 1, wherein at least one of
the first radio access technology is a long term evolution technology;
the first other network is one of a global system for mobile communication edge radio access network and a universal mobile telecommunication radio access network; and
the second other network is one of a global system for mobile communication edge radio access network and a universal mobile telecommunication radio access network.

3. The apparatus according to claim 1, wherein at least one of
the first network element comprises a mobility management entity; and
the part of the second network element is a routing area.

4. The apparatus according to claim 1, wherein the mapped identifier identifies a pool of at least one network element of a kind of the first network element.

5. The apparatus according to claim 1, wherein the providing processor is adapted to provide at least one of a mapped indication indicating that the mapped identifier is mapped and a native indication indicating that the old identifier is native.

6. User equipment, comprising an apparatus according to claim 1.

7. Apparatus, comprising retrieving processor configured to retrieve a mapped identifier and a native identifier out of a message received from a terminal device during a mobility procedure to the apparatus;
selecting processor configured to select a selected network element to which the terminal device is to be registered based on at least one of the mapped identifier and the native identifier.

8. The apparatus according to claim 7, further comprising
failure detecting processor configured to detect if the selected network element is not connected to the apparatus; wherein
the selecting processor is configured to select the selected network element based on the native identifier first; and,
if the failure detecting processor detects that the selected network element which is selected based on the native identifier is not connected to the apparatus, the selecting processor is configured to select the selected network element based on the mapped identifier.

9. The apparatus according to claim 7, wherein at least one of
the native identifier identifies unambiguously a network element of a kind of the selected network element, and
the mapped identifier identifies a pool of at least one network element of the kind of the selected network element.

10. The apparatus according to claim 7, wherein the apparatus belongs to a long term evolution radio access technology.

11. The apparatus according to claim 7, wherein the selected network element comprises a mobility management entity.

12. The apparatus according to claim 7, wherein the mapped identifier is based on a routing area of one of a global system for mobile communication edge radio access network and a universal mobile telecommunication radio access network.

13. Base station, comprising an apparatus according to claim 7.

14. Method, comprising
monitoring whether an apparatus performing the method is to perform a first mobility procedure from a first network of a first radio access technology to a first other network of a second radio access technology different from the first radio access technology;
storing, in a memory, an old identifier when the apparatus is to perform the first mobility procedure, wherein the old identifier identifies a first network element of the first network to which the apparatus is registered before the first mobility procedure starts;
monitoring whether the apparatus performs a second mobility procedure from a second other network of a third radio access technology different from the first radio access technology to a second network of the first technology;
retrieving the stored old identifier from the memory;
providing a mapped identifier and the retrieved old identifier to a base station of the second network when the apparatus performs the second mobility procedure, wherein the mapped identifier is mapped based on an identification of a part of the second other network to which the apparatus is registered before the second mobility procedure starts.

15. The method according to claim 14, wherein at least one of
the first radio access technology is a long term evolution technology;
the first other network is one of a global system for mobile communication edge radio access network and a universal mobile telecommunication radio access network; and
the second other network is one of a global system for mobile communication edge radio access network and a universal mobile telecommunication radio access network.

16. The method according to claim 14, wherein at least one of
the first network element comprises a mobility management entity; and
the part of the second network element is a routing area.

17. The method according to claim 14, wherein the mapped identifier identifies a pool of at least one network element of a kind of the first network element.

18. The method according to claim 14, further comprising providing at least one of a mapped indication indicating that the mapped identifier is mapped and a native indication indicating that the old identifier is native.

19. Method, comprising
retrieving a mapped identifier and a native identifier out of a message received from a terminal device during a mobility procedure to an apparatus performing the method;
selecting a selected network element to which the terminal device is to be registered based on at least one of the mapped identifier and the native identifier.

20. The method according to claim 19, further comprising
detecting if the selected network element is not connected to the apparatus; wherein
the selecting is configured to select the selected network element based on the native identifier first; and,
if it is detected that the selected network element which is selected based on the native identifier is not connected to the apparatus, the selecting is configured to select the selected network element based on the mapped identifier.

21. The method according to claim 19, wherein at least one of
the native identifier identifies unambiguously a network element of a kind of the selected network element, and
the mapped identifier identifies a pool of at least one network element of the kind of the selected network element.

22. The method according to claim 19, wherein the apparatus belongs to a long term evolution radio access technology.

23. The method according to claim 19, wherein the selected network element comprises a mobility management entity.

24. The method according to claim 19, wherein the mapped identifier is based on a routing area of one of a global system for mobile communication edge radio access network and a universal mobile telecommunication radio access network.

25. A computer program product embodied on a non-transitory computer-readable medium, said product comprising a set of instructions which, when executed on an apparatus, is configured to cause the apparatus to carry out the method according to claim 14.

26. A computer program product embodied on a non-transitory computer-readable medium, said product comprising a set of instructions which, when executed on an apparatus, is configured to cause the apparatus to carry out the method according to claim 19.
